(19) United States
(12) Patent Application Publication
(10) Pub. No.: US 2009/0266914 A1
(43) Pub. Date: Oct. 29, 2009

(54) APPARATUS FOR SELECTIVELY DISPENSING FERTILIZER, PESTICIDE AND THE LIKE THROUGH A FLUID FLOW LINE

(76) Inventor: Steven Messina, Fremont, OH (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/304,521

(22) PCT Filed: May 14, 2007
(86) PCT No.: PCT/US07/68852

§ 371 Date: Dec. 12, 2008

Related U.S. Application Data
(60) Provisional application No. 60/804,604, filed on Jun. 13, 2006.

(51) Int. Cl. B05B 7/14

(52) U.S. Cl. 239/303

(57) ABSTRACT

An apparatus has a fluid flow portion that is introduced as part of a fluid flow continuum. The fluid flow portion is situated above a plurality of liquid-holding chambers. Each chamber forms a fluid flow continuum from the chamber through a tube-like structure that intersects the fluid flow portion. A control means is provided to set the fluid flow from the chamber at a determined level. An alternative embodiment provides an apparatus that is fully portable.

This application claims the benefit and priority of U.S. Provisional Patent Application No. 60/804,604 filed Jun. 13, 2006.

### FIELD OF THE INVENTION

This invention relates generally to fluid distribution systems and to devices that are used in such systems for controlling the flow of fluid, such as water, and for adding chemicals, such as liquid fertilizers, to such fluid during flow. More particularly, it relates to a multi-chambered apparatus that can contain a plurality of water-soluble chemicals or water additives, the apparatus being placed in-line with respect to the fluid flow for distribution of the chemicals and additives together with the water that passes through the apparatus. It also relates to such an apparatus that allows for separately controllable feed rates from each of the chambers contained within the apparatus. It also relates to such an apparatus that can be used in a fixed in-line position relative to the fluid distribution system or that can, in an alternative embodiment, be used as a portable unit.

### BACKGROUND OF THE INVENTION

Irrigation systems and fluid distribution devices of such systems are known in the art. Indeed, water has been carried by means of stone, wood, and metal piping for centuries. More recently, plastic piping and rubber tubing has made water distribution a way of life in our modern society.

Also known in the art are ways of introducing liquid chemicals, most typically in the form of fertilizers, weed killers and pesticides, into the flow stream. Methods of doing this include, for example, using wick-like feeders to draw a liquid chemical from a reservoir along the wick and then into the flow stream, a portion of the wick being disposed within that flow stream. Other methods include single use bottles and the like for mixing a liquid chemical with the fluid flow stream by means of a venturi-type tube arrangement. In this last configuration, a localized low pressure area is created along the primary flow stream whereby liquid chemical is drawn from the bottle, through the tube, and is fed into the flow stream. Also in this last configuration, the flow of liquid chemical is typically accomplished at a fixed rate. That is, the flow of liquid chemical from the bottle is always in accordance with a rate that is a function of the flow velocity of the stream and of the size of the opening through which the liquid chemical is fed into the flow stream. One of the drawbacks of this prior art is the very fact that the flow rate is not variable. Another drawback is the fact that only one reservoir, such as a bottle, can typically be used at a time. If more than one bottle is to be used, such as where it would be desired to introduce several different liquid chemicals into the liquid flow, each chemical being used for a specific purpose, the chemicals would need to be separately applied or the bottles would need to be separately connected to the line, all through a single venturi-type tube. Indeed, the prior art known to this inventor is limited to individual reservoirs being capable of feeding chemicals or other liquids through a single venturi-type orifice, such as through a spray nozzle.

In the view of this inventor, what is needed is an in-line apparatus that is comprised of a self-contained unit having multiple chambers for introducing one or more liquids into a fluid flow, and where the feed rate from each chamber is variably adjustable. What is also needed is such an apparatus that can be placed in-line with the fluid flow structure such that the apparatus is more or less a permanent part of the fluid flow continuum. What is also needed is such an apparatus that can, in an alternative embodiment, be constructed for temporary use within any fluid flow continuum, including garden hoses that are connected to a water faucet at one end and to a water delivery device, such as a lawn sprinkler, at the opposite end.

### SUMMARY OF THE INVENTION

It is, therefore, a principal object of this invention to provide a new, useful, and uncomplicated in-line apparatus that is a self-contained unit having multiple chambers for introducing one or more liquids into a fluid flow. It is another object of the present invention to provide such an apparatus where the feed rate from each chamber is variably adjustable. It is still another object of the present invention to provide such an apparatus that can be placed in-line with existing fluid flow structure whereby the apparatus is essentially a permanent part of the fluid flow continuum. It is yet another object of the present invention to provide such an apparatus that can, in an alternative embodiment, be constructed for temporary usage within any fluid flow continuum, which could include garden hoses that are connected at one end to a water faucet and at the opposite end to a water delivery device, such as a lawn sprinkler. It is still another object of the present invention to provide such an alternative embodiment that is fully portable such that the apparatus can be easily moved from one location to another by the user, as may be desired or required by the user.

The present invention has obtained these objects. In a first preferred embodiment, it provides for an apparatus having a fluid flow portion that can be introduced as part of the fluid flow continuum. The fluid flow portion is situated above a plurality of liquid-holding chambers. Each chamber is isolated from the others and is separately accessible by the user for refilling the chamber with a liquid. Each chamber forms a flow continuum from the chamber through a tube-like structure that intersects the fluid flow portion at a point. Disposed within the tube-like structure is a control means for setting the fluid flow from the chamber at a determined level. The control means allows the liquid to be fed into the fluid flow at a rate that is desired or required by the user. The control means also allows the settings of the control means to be separately adjustable from other control means, thus allowing several liquids to flow from the apparatus at different rates and in different levels to accomplish the distribution of a liquid fertilizer or the like through the apparatus. An alternative embodiment provides an apparatus that is fully portable for use with conventional faucet, hose and sprinkler combinations. Various other alternative embodiments and configurations for the apparatus of the present invention are also contemplated by this inventor and are incorporated herein.

The foregoing and other features of the in-line apparatus that is constructed in accordance with this invention will be apparent from the detailed description that follows.

### BRIEF DESCRIPTION OF THE DRAWINGS

FIG. 1 is a front, top and right-side perspective view of a first preferred embodiment of an in-line apparatus that is constructed in accordance with the present invention.

FIG. 2 is a side elevational and cross-sectioned view of the in-line apparatus that is illustrated in FIG. 1.

FIG. 3 is a top plan and cross-sectioned view of the first preferred embodiment of the in-line apparatus that is illustrated in FIGS. 1 and 2.

FIG. 4 is a front elevational and cross-sectioned view of the first preferred embodiment of the in-line apparatus that is illustrated in FIGS. 1 through 3 and taken along line 4-4 of FIG. 3.

FIG. 5 is a side elevational and cross-sectioned view of a second preferred embodiment of an in-line apparatus that is constructed in accordance with the present invention.

### DETAILED DESCRIPTION

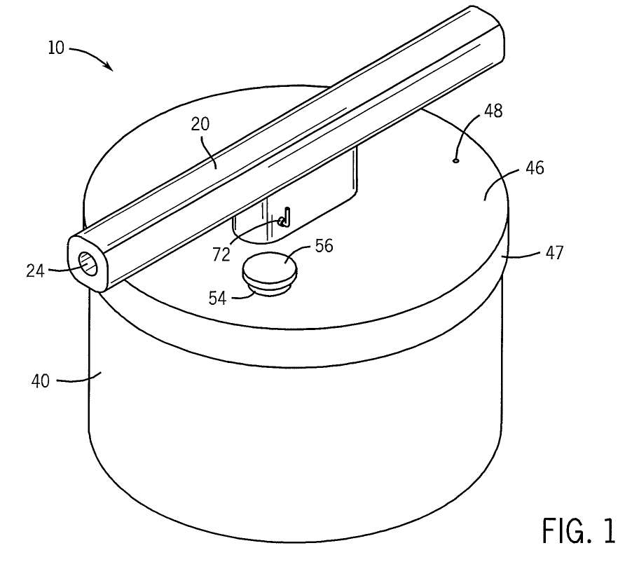

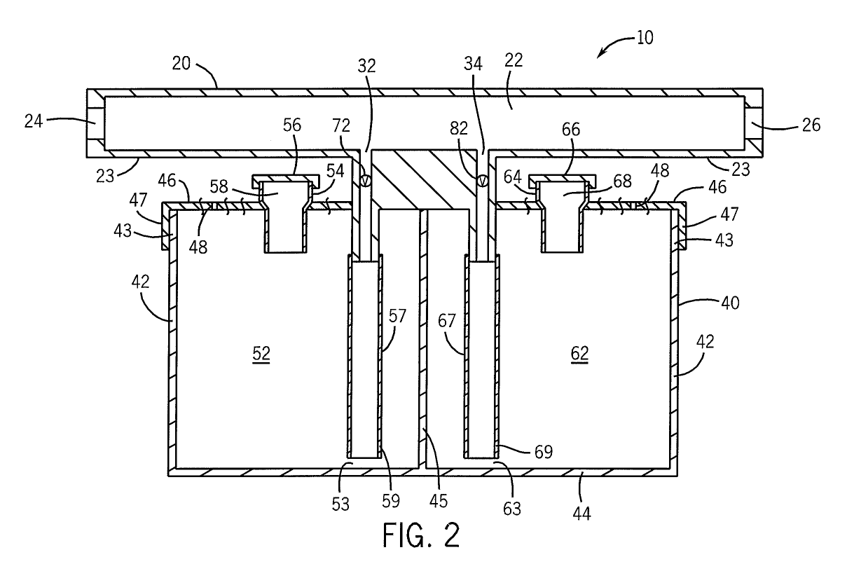

Referring now to the drawings in detail, wherein like numbered elements refer to like elements throughout, FIGS. 1 and 2 illustrate a first preferred embodiment of an apparatus, generally identified as 10, that is constructed in accordance with the present invention. As shown, the apparatus 10 includes a primary fluid flow conduit portion 20, the conduit portion 20 including an inlet end 24 and an outlet end 26. Each of the inlet end 24 and the outlet end 26 is functionally adapted for securement to a fluid flow line of conventional manufacture such that this first embodiment of the apparatus 10 simply becomes part of the overall fluid distribution system. Such systems might include, but are not limited to, home and commercial irrigation systems for periodically distributing water to a lawn or the like. It is to be understood that this first embodiment of the apparatus 10 is not limited to application with or use in any particular system.

Disposed between the inlet end 24 and the outlet end 26 of the apparatus 10 is a longitudinally-extending flow tube hollow 22. Although the hollow 22 is substantially cylindrical in shape, it is to be understood by those skilled in the art that it is not limited to that configuration. Other shapes could be used without deviating from the scope of this invention. It is also to be understood that, although the hollow 22 is disclosed and illustrated as a single tube-like structure, the hollow 22 could be configured as a multiple-apertured structure within the conduit portion 20 of the apparatus 10 without deviating from the scope of the present invention. The outlet end 26 could similarly be constructed as a multiple-apertured structure to allow for the attachment of multiple outlet feed lines to the apparatus 10 as well. Situated directly below the conduit portion 20 is a chamber portion 40. The chamber portion 40 generally includes a sidewall 42, the sidewall being continuous about an outer perimeter and floor 44. The sidewall 42 is substantially cylindrical in shape. However, it is to be understood that the chamber portion 40 of the apparatus 10 is not limited to that shape. The chamber portion 40 could be ovate, square or rectangular without deviating from the scope of the present invention.

Referring again to FIG. 2, it will be seen that the chamber portion 40 includes a first chamber 52 and a second chamber 62. Here again, the chamber portion 40 could include more than two chambers and still come within the scope of the present invention and the invention is not so limited. Each chamber would, however, be a self-contained reservoir for holding a liquid within it. It is to be understood, however, that alternative embodiments of the apparatus of the present invention could be configured to provide chambers that interact between one another. For example, a first chamber could be provided that is filled with a concentrated liquid chemical in it, the first chamber feeding into the second chamber in accordance with the present invention to dilute the concentrated liquid chemical prior to entry of the final concentration into the flow stream. In another alternative embodiment two chemical chambers could interact to product a third chemical, the third chemical being produced only upon combination of the two chemicals within the flow stream or immediately before entry into the flow stream. Such is not a limitation of the present invention.

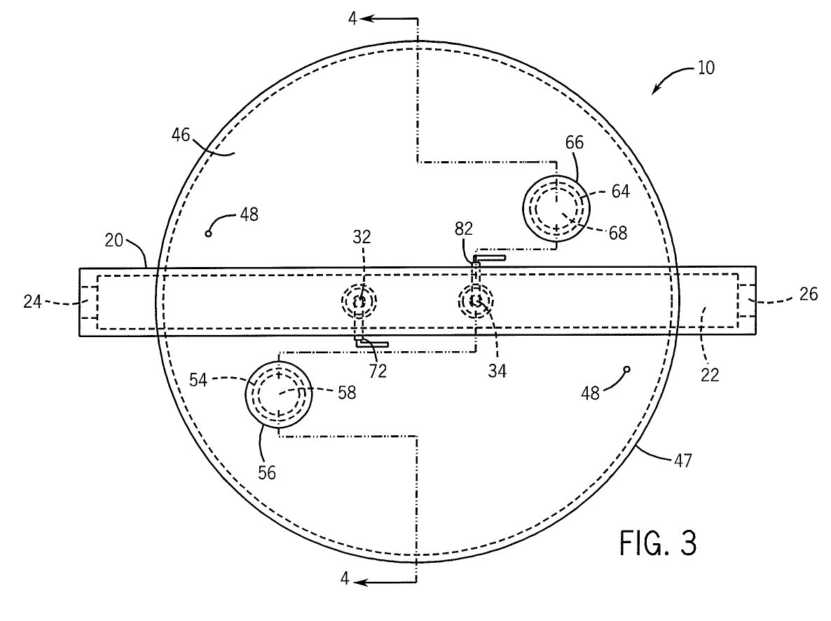

In the preferred embodiment, a cover 46 sits atop the uppermost portion 43 of the base sidewall 42. The lip 47 of the cover 46 sealingly surrounds the base sidewall 42, covering both chambers 52, 62, and creating a secure reservoir for any liquid (not shown) being held within the chambers 52, 62. It should also be mentioned here that the engagement of the cover 46 at its lip 47 with the uppermost portion 43 of the sidewall 42 is preferred to be a sealing engagement. However, the cover 46 and the sidewall 42 could also include cooperating threads, interlocking tabs, or any other suitable engagement means that is known to those skilled in the art. A gasket (not shown) could also be disposed between the uppermost portion 43 of the sidewall 42 and the cover 46 to enhance the sealing engagement between the two structures. Situated between the first and second chambers 52, 62, respectively, is a common dividing wall 45. At the cover 46, the first chamber 52 includes a fill member 54 having a fill aperture 58. See also FIG. 3. This fill member 54 is used to periodically replenish or replace the liquid (not shown) that would be held within the first chamber 52. A cap 56 is also provided to seal off the fill member 54 once the chamber 52 has been filled to prevent any substance from accidentally or unintentionally entering the chamber 52. Similarly, the second chamber 62 includes a fill member 64 having a fill aperture 68 and a cap 66, all for the same purpose stated relative to the first chamber 52. The cover 46 also includes a pair of small air inlet apertures 48 for equalizing pressure within each of the chambers 52, 62 as liquid is drawn out of each reservoir.

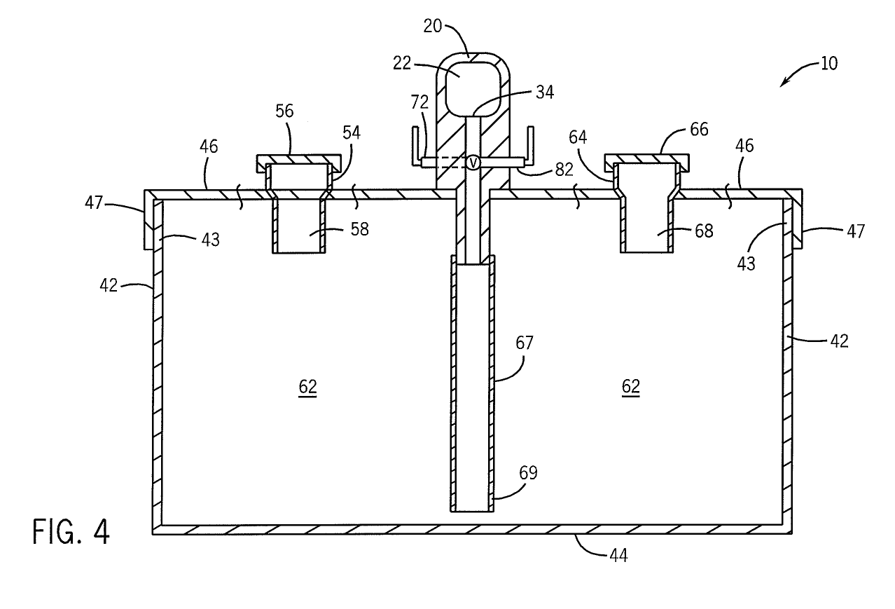

The flow conduit portion 20 of the apparatus 10 includes a pair of flow apertures 32, 34 that are defined within the bottom wall 23 of the flow tube hollow 22. Extending downwardly from the first aperture 32 is a flow control means 72, the purpose and function of which will be explained later in this detailed description. Similarly, a second flow control means 82 is disposed immediately below the second aperture 34. Below the first flow opening 32 is a plastic tube 57 that extends downwardly into the bottom-most portion 53 of the first chamber 52. The lower-most portion 59 of the plastic tube 57 is also near the floor 44 of the base 40 and disposed in this fashion so as to draw as much liquid from the first chamber 52 as is possible during use of the apparatus 10. Further, a similar plastic tube 67 having a lower most portion 69 is disposed within the bottom-most portion 63 of the second chamber 62 for the same purpose and functionality. See also FIG. 4.

In application, the user would remove the cap 56 from the fill member 54 and pour a first liquid, such as a liquid fertilizer, into the chamber 52 of the chamber portion 40. Similarly, a second fluid, such as a liquid pesticide, could be placed within the second chamber 62 through the liquid fill member 64 defined within the base cap 46. Note again that the flow of air into each of the chambers 52, 62 is allowed by means of the air inlet holes 48 that are defined within the cap 46. See FIG. 3.

Once each chamber 52, 62 has been filled with liquid, water flow will be introduced into the apparatus 10 from the inlet end 24 of the flow tube hollow 22. As water flows through the hollow 22, a localized low pressure venturi force will act upon the first aperture 32 and upon the second aperture 34 to draw fluid up into the plastic tubes 57, 67 that are disposed within the first and second chamber portions 52, 62, respectively. The flow of the fluid from within each of the chamber portions 52, 62 is controlled by means of a regulating valve 72, 82, respectively. It should be noted that, although a manual-type control valve 72, 82 is illustrated in this first embodiment, other alternative flow control means or methodology could be used without deviating from the scope of the invention. For example, a screw feed mechanism that slowly opens or closes the aperture at the point of the valve could be used. Also, butterfly valves could be used for flow rate control as well. It would also be possible to have the flow controlled electronically by means of an external central processing unit (CPU) in accordance with a pre-programmed scheme to provide outflow as is desired or required by the user. In this fashion, a desirable amount of fertilizer and pesticide can be distributed across the lawn in a uniform fashion to accomplish the intended result. The flow rates of each chamber 52, 62 can be adjusted or changed from time to time as is desired or required by the user with little more than an adjustment of/to the regulating valves 72, 82 or alternative flow control means or methodology. Additionally, flow may be completely stopped with respect to the contents of one or the other of the chambers 52, 62 if such became necessary while allowing the other chamber 52, 62 to continue to empty its fluid contents into the main water flow that is discharged from the outlet end 26 of the apparatus 10.

The aforementioned preferred embodiment could also be configured to function where the fluid flow from the first and second chamber portions 52, 62 is by gravity. That is, the apparatus 10 could be alternatively configured whereby the primary fluid flow conduit portion 20 is disposed at the bottom of the apparatus 10 and fluid flows out of the chambers 52, 62 at a controlled rate. This alternative configuration would not utilize the plastic tubes 57, 67 but would require that apertures (not shown) be formed into the floor 44. The control valves 72, 82 would be disposed at such apertures and could be controlled as described above. This alternative configuration would also benefit by the use of caps 56, 66 that would be vented, such as by the presence of a small aperture (also not shown) defined in each cap 56, 66, such aperture effectively replacing the cover apertures 48.

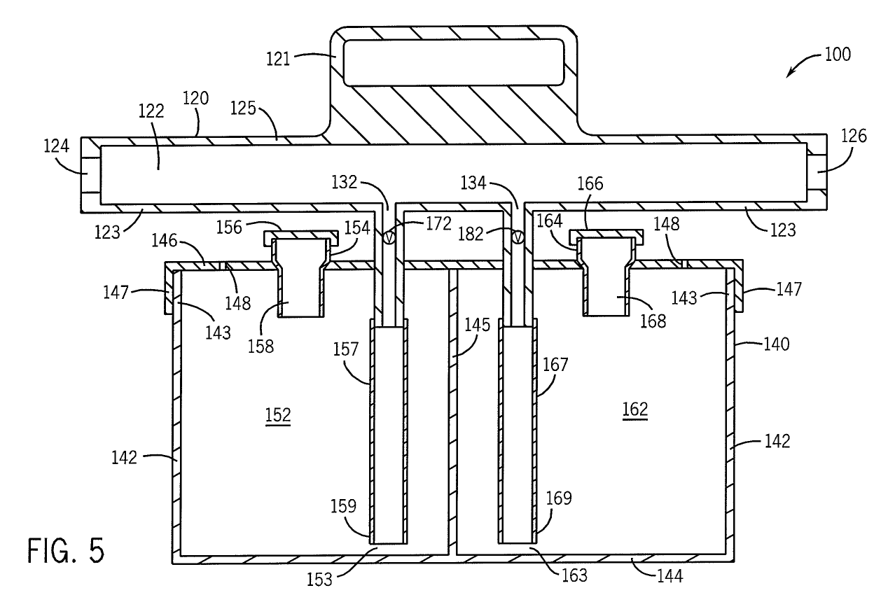

Referring now to FIG. 5, it will be seen that an alternative embodiment of the apparatus 10 is illustrated, generally identified as 100. As shown, the apparatus 100 includes a primary fluid flow conduit portion 120, the conduit portion 120 including an inlet end 124 and an outlet end 126, much the same as the first embodiment of the apparatus. The inlet end 124 and the outlet end 126 are each functionally adapted for temporary securement to a fluid flow line of conventional manufacture. In this way, this alternative embodiment of the apparatus 100 simply becomes part of the temporary fluid distribution system. Such systems might include, but are not limited to, home and commercial irrigation systems that are comprised of a conventional faucet connection, one or more hoses, and a sprinkler device. The apparatus 100 of the alternative embodiment could be interposed at any point along the water flow continuum of such a system. It is also to be understood that this second embodiment of the apparatus 100 is not limited to application with or use in any particular system.

Disposed between the inlet end 124 and the outlet end 126 of the apparatus 100 is a longitudinally-extending flow tube hollow 122. As with the first embodiment, the hollow 122 is substantially cylindrical in shape. It is to be understood, however, that it is not limited to that configuration. Other shapes could be used without deviating from the scope of this invention. Situated directly below the conduit portion 120 is a chamber portion 140. The chamber portion 140, as shown in FIG. 5, includes a sidewall 142, the sidewall 142 being continuous about an outer perimeter and a floor 144. As was true of the first embodiment, the sidewall 142 is substantially cylindrical in shape, it being understood that the chamber portion 140 of the apparatus 100 is not limited to that shape. The chamber portion 140 could assume other shapes without deviating from the scope of the present invention.

Referring still to FIG. 5, it will be seen that the chamber portion 140 includes a first chamber 152 and a second chamber 162. Here again, the chamber portion 140 could include more than two chambers and still come within the scope of the present invention and the invention is not so limited, each chamber being a self-contained reservoir for holding a liquid within it.

In the alternative embodiment, a cover 146 sits atop the uppermost portion 143 of the base sidewall 142. The cover 146 includes a lip 147 that surrounds the base sidewall 142 and covers both chambers 152, 162, thus creating a secure reservoir for any liquid being held within the chambers 152, 162. Situated between the first and second chambers 152, 162, respectively, is a common dividing wall 145. At the cover 146, the first chamber 152 includes a fill member 154 having a fill aperture 158. This fill member 154 is used to replenish or replace the liquid that would be held within the first chamber 152. A cap 156 is provided to seal off the fill member 154 once the chamber 152 has been filled. Similarly, the second chamber 162 includes a fill member 164 having a fill aperture 168 and a cap 166, all of which mirrors similar structure of the first chamber 152. The cover 146 also includes air inlet apertures 148 for equalizing pressure within each of the chambers 152, 162 as liquid is drawn out of each reservoir.

The flow conduit portion 120 of the apparatus 100 includes a pair of flow apertures 132, 134 that are defined within the bottom wall 123 of the flow tube hollow 122. Extending upwardly from the top wall 125 of the flow tube hollow 122 is an integrally-formed handle portion 121. The handle portion 121 allows the apparatus 100 to be movable between locations by the user. Although shown as an integral member of the flow conduit portion 120, it is to be understood that the handle portion 121 could be separately attached to the apparatus without deviating from the scope of this alternative embodiment of the present invention.

Extending downwardly from the first aperture 132 is a flow control means 172. A second flow control member 182 is disposed immediately below the second aperture 134. Below the first flow opening 132 is a plastic tube 157 that extends downwardly into the bottom most portion 153 of the first chamber 152. The lower-most portion 159 of the plastic tube 157 is also near the floor 144 of the base 140 and disposed in this fashion so as to draw as much liquid from the first chamber 152 as is possible during use of the apparatus 100. Further, a similar plastic tube 167 having a lower most portion 169 is disposed within the second chamber 162 for the same purpose and functionality.

As with the first embodiment, application of the second embodiment of the apparatus 100 would require that the user remove the cap 156 from the fill member 154 and pour a first liquid, such as a liquid fertilizer, into the chamber 152 of the chamber portion 140. A second fluid, such as a liquid pesticide, could be poured into the second chamber 162 through the liquid filler opening 164 defined within the base cap 146. Note again that the flow of air into each of the chambers 152, 162 is allowed by means of the air inlet holes 148 that are defined within the base cap 146.

Once each chamber 152, 162 has been filled with liquid, water flow will be established through the apparatus 100 by connecting the inlet end 124 of the flow tube hollow 122 to a first hose member (not shown) or alternative fluid delivery device. The outlet end 126 would be similarly connected to a second hose member (also not shown) or alternative fluid delivery device. Note that these connections would be made once the apparatus 100 is situated in its preferred location by the user. As water flows through the hollow 122, a venturi force will act upon the first aperture 132 and upon the second aperture 134 to draw fluid up into the plastic tubes 157, 167 that are disposed within the first and second chamber portions 152, 162, respectively. The flow of the fluid from within each of the chamber portions 152, 162 is controlled by means of the regulating valves 172, 182, respectively. Again, it should be noted that, although a manual-type control valve 172, 182 is illustrated in this second embodiment, other means could be used without deviating from the scope of the invention as was disclosed with the first embodiment of the apparatus 10. For example, a screw feed mechanism that slowly opens or closes the aperture at the point of the valve could be used. Also, butterfly valves could be used for flow rate control as well. It would also be possible to have the flow controlled electronically by means of an external central processing unit (CPU) in accordance with a pre-programmed scheme to provide outflow as is desired or required by the user. In this fashion, a desirable amount of fertilizer and/or pesticide could be distributed across the lawn in a uniform fashion to accomplish the intended result. The flow rates of each chamber 152, 162 could be adjusted or changed from time to time as is desired or required by the user with little more than an adjustment of/to the regulating valves 172, 182 or alternative flow control means or methodology. Also, flow may be completely stopped with respect to the contents of one or the other of the chambers 152, 162 if such became necessary while allowing the other chamber 152, 162 to continue to empty its fluid contents into the main water flow that is discharged from the outlet end 126 of the apparatus 100.

The aforementioned alternative embodiment could also be configured to function whereby the fluid flow from the first and second chamber portions 152, 162 is by gravity. That is, the apparatus 100 could be alternatively configured whereby the primary fluid flow conduit portion 120 is disposed at the bottom of the apparatus 100 and fluid flows out of the chambers 152, 162, again at a controlled rate. This alternative configuration would not utilize the plastic tubes 157, 167 but would require that apertures (not shown) be formed within the floor 144. The control valves 172, 182 would be disposed at such apertures and could be controlled as described above. This alternative configuration would also benefit by the use of caps 156, 166 that would be vented, such as by the presence of a small aperture (also not shown) defined in each cap 156, 166, such aperture effectively replacing the cover apertures 148. Again, various other alternative embodiments and configurations for the apparatus of the present invention are contemplated by this inventor and are incorporated herein.

In view of the foregoing, it will be seen that there have been provided in this disclosure several embodiments of a new, useful, non-obvious and uncomplicated in-line apparatus that is a self-contained unit having multiple chambers for introducing one or more liquids into a fluid flow; where the feed rate from each chamber is variably adjustable; that can be placed in-line with existing fluid flow structure whereby the apparatus is essentially a permanent part of the fluid flow continuum; that can, in an alternative embodiment, be constructed for temporary usage within any fluid flow continuum, which could include garden hoses that are connected at one end to a water faucet and at the opposite end to a water delivery device, such as a lawn sprinkler; and that is fully portable such that the apparatus can be easily moved from one location to another by the user, as may be desired or required by the user. The embodiments described in this application are not exhaustive but recited for purposes of explanation and enablement to one skilled in the art.

The principles of this invention having been described in accordance with the foregoing, I claim:

1. An apparatus for selectively dispensing liquid fertilizer, pesticide and the like, through a fluid flow line having a fluid flow continuum, which comprises
a fluid flow portion that can be introduced as part of a fluid flow continuum,
a plurality of liquid-holding chambers, and
means for selectively flowing liquid from the plurality of chambers.

2. The apparatus of claim 1 wherein each chamber of the plurality of chambers is isolated from the others and is separately accessible for refilling that chamber with a liquid.

3. The apparatus of claim 2 wherein each chamber of the plurality of chambers forms a flow continuum from the chamber through a separate tube-like structure that intersects the fluid flow portion at a point.

4. The apparatus of claim 3 wherein the tube-like structure comprises a control means for selecting the rate of fluid flow from the chamber whereby the control means allows the liquid to be fed into the fluid flow portion at a desired rate.

5. The apparatus of claim 4 wherein the control means for each chamber allows the settings of the control means for that chamber to be separately adjustable from the control means of the other chambers whereby several liquids can flow from the apparatus at different rates and in different amounts.

6. The apparatus of claim 5 wherein the apparatus is fully portable for in-line usage with conventional faucet, hose and sprinkler combinations, one or more selected from a group consisting of a faucet or faucets, a hose or hoses, and a sprinkler or sprinklers.

7. An apparatus for use with a fluid distribution system and for selectively dispensing liquid fertilizer, pesticide and the like into the fluid distribution system, the apparatus comprising:
a primary fluid flow conduit portion, the conduit portion including an inlet end and an outlet end, each of the inlet end and the outlet end being functionally adapted to be secured to a fluid flow line of conventional manufacture such that the apparatus becomes part of the overall fluid distribution system,
a longitudinally-extending flow tube hollow disposed between the inlet end and the outlet end of the primary flow conduit portion, said flow tube hollow comprising a tube hollow bottom wall,
a base portion situated directly below the conduit portion, the base portion including a sidewall, the sidewall having an uppermost portion and being continuous about an outer perimeter, and a floor, the base portion comprising a plurality of chambers, each chamber being a self-contained reservoir for holding a liquid within it,
a cover that sits atop the uppermost portion of the base sidewall, the cover having a lip that sealingly surrounds the base sidewall, covering both chambers and creating a secure reservoir for any liquid held within the chambers,
at least one dividing wall situated between the plurality of chambers,
a fill member and aperture defined within the cover and located above each chamber, the fill member and aperture being used to periodically replenish or replace the liquid held within each chamber,
a cap to seal off the fill member and aperture to prevent any substance from accidentally or unintentionally entering the chamber,
air inlet apertures defined within the cover for equalizing pressure within each of the chambers as liquid is drawn out of each,
a flow aperture defined within the bottom wall of the flow tube hollow for each chamber,
a flow control means extending downwardly from the flow aperture for each chamber, and
a tube that extends downwardly from the flow aperture and into the bottom-most portion of the chamber.

8. The apparatus of claim 7 wherein the longitudinally-extending flow tube hollow is substantially cylindrical in shape.

9. The apparatus of claim 7 wherein the longitudinally-extending flow tube hollow is configured as a multiple-apertured structure.

10. The apparatus of claim 7 wherein the outlet end of the longitudinally-extending flow tube hollow is constructed as a multiple-apertured structure to allow for the attachment of multiple outlet feed lines to the apparatus.

11. The apparatus of claim 7 wherein the base sidewall is substantially cylindrical in shape.

12. The apparatus of claim 7 wherein the base sidewall is configured in one from a group consisting of ovate, square or rectangular shapes.

13. The apparatus of claim 7 wherein the base is comprised of at least two chambers.

14. The apparatus of claim 7 wherein the apparatus is configured to provide chambers that interact with one another for dispensing combinations of liquid fertilizers, pesticides and the like through the fluid flow line.

15. The apparatus of claim 7 wherein the cover and the uppermost portion of the sidewall include cooperating threads, interlocking tabs, or any other suitable engagement means.

16. The apparatus of Claim 7 wherein a gasket is disposed between the uppermost portion of the sidewall and the cover to enhance the sealing engagement between those two structures.

17. The apparatus of claim 7 wherein the apparatus is fully portable for in-line usage with conventional faucet, hose and sprinkler combinations, one or more selected from a group consisting of a faucet or faucets, a hose or hoses, and a sprinkler or sprinklers.
